(19) United States
(12) Patent Application Publication
(10) Pub. No.: US 2025/0274310 A1
(43) Pub. Date: Aug. 28, 2025

(54) SIGNAL TRANSMITTING METHOD AND APPARATUS IN WIRELESS COMMUNICATION SYSTEM

(71) Applicants: LG Electronics Inc., Seoul (KR); Korea Advanced Institute of Science and Technology, Daejeon (KR)

(72) Inventors: Junil CHOI, Daejeon (KR); Jae Yong PARK, Seoul (KR); Sungjin KIM, Seoul (KR); Hyeongtaek LEE, Daejeon (KR); Jihoon CHA, Daejeon (KR); Sucheol KIM, Daejeon (KR)

(21) Appl. No.: 18/692,957

(22) PCT Filed: Sep. 17, 2021
(86) PCT No.: PCT/KR2021/012869

§ 371 Date: Sep. 18, 2024

(51) Int. Cl. H04L 25/02; H04B 7/04

(52) U.S. Cl. CPC H04L 25/0224; H04B 7/04013

(57) ABSTRACT

Disclosed herein is a base station in a wireless communication system, including receiving a first pilot signal from a terminal and estimating a channel between the terminal and the base station based on the first pilot signal, receiving a second pilot signal corresponding to an intelligent reflecting surface (IRS) element configuration from the terminal through an IRS, receiving a feedback signal of a third pilot signal corresponding to the IRS configuration from the terminal through the IRS, and estimating a channel corresponding to a specific IRS based on the first pilot signal, the second pilot signal and the third pilot signal. The second pilot signal is an uplink pilot signal, and the third pilot signal is a downlink pilot signal.

### TECHNICAL FIELD

The present disclosure relates to a wireless communication system, and more particularly, to a device and method for channel estimation in a wireless communication system.

### BACKGROUND ART

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### DISCLOSURE

### Technical Problem

The present disclosure may provide a device and method for channel estimation in a wireless communication system.

The present disclosure may provide a device and method for channel estimation in a wireless communication system including a intelligent reflecting surface (IRS).

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

### Technical Solution

As an example of the present disclosure, a method for operating a base station in a wireless communication system may include receiving a first pilot signal from a terminal and estimating a channel between the terminal and the base station based on the first pilot signal, receiving a second pilot signal corresponding to an intelligent reflecting surface (IRS) element configuration from the terminal through an IRS, receiving a feedback signal of a third pilot signal corresponding to the IRS element configuration from the terminal through the IRS, and estimating a channel corresponding to a specific IRS element based on the first pilot signal, the second pilot signal and the third pilot signal. The second pilot signal is an uplink pilot signal, and the third pilot signal is a downlink pilot signal. As a concrete example, the channel estimation corresponding to the specific IRS element may remove a channel impact between the terminal and the base station from the second pilot signal and remove a channel impact between the terminal and the base station from the third pilot signal. As another example, the channel estimation corresponding to the specific IRS element may remove a channel impact between the terminal and the base station from the second pilot signal and receive the third pilot signal with the channel impact between the terminal and the base station being removed. In addition, the channel estimation corresponding to the specific IRS element may be repeated for every IRS element. The IRS element configuration may be a configuration in which a specific IRS element is turned on, and the IRS may be composed of a passive element alone. The base station may transmit IRS element configuration information to the terminal. The IRS element configuration information may include information on a number of the specific IRS element which is turned on. The first pilot signal and the second pilot signal may be sounding reference signals (SRS). The third pilot signal may be a channel state information-reference signal (CSI-RS).

As an example of the present disclosure, a base station in a wireless communication system may include a transceiver and a processor coupled to the transceiver. The processor may control the transceiver to receive a first pilot signal from a terminal. The processor may estimate a channel between the terminal and the base station based on the first pilot signal. The processor may control the transceiver to receive a second pilot signal corresponding to an intelligent reflecting surface (IRS) element configuration from the terminal through an IRS. The processor may control the transceiver to receive a feedback signal of a third pilot signal corresponding to the IRS element configuration from the terminal through the IRS. The processor may estimate a channel corresponding to a specific IRS element based on the first pilot signal, the second pilot signal and the third pilot signal. The second pilot signal is an uplink pilot signal, and the third pilot signal is a downlink pilot signal. As a concrete example, channel estimation corresponding to the specific IRS element may remove a channel impact between the terminal and the base station from the second pilot signal and remove a channel impact between the terminal and the base station from the third pilot signal. As another example, the channel estimation corresponding to the specific IRS element may remove a channel impact between the terminal and the base station from the second pilot signal and receive the third pilot signal with the channel impact between the terminal and the base station being removed. The processor may repeat the channel estimation corresponding to the specific IRS element for every IRS element. The IRS element configuration may be a configuration in which a specific IRS element is turned on, and the IRS may be composed of a passive element alone. The processor may control the transceiver to transmit IRS element configuration information to the terminal. The IRS element configuration information may include information on a number of the specific IRS element which is turned on. The first pilot signal and the second pilot signal may be sounding reference signals (SRS). The third pilot signal may be a channel state information-reference signal (CSI-RS).

As an example of the present disclosure, a communication device may include at least one processor and at least one computer memory coupled to the at least one processor and storing an instruction which instructs operations when executed by the at least one processor. The processor may control the communication device to receive a first pilot signal from a terminal and to estimate a channel between the terminal and a base station based on the first pilot signal. The processor may control the communication device to receive a second pilot signal corresponding to an intelligent reflecting surface (IRS) element configuration from the terminal through an IRS. The processor may control the communication device to receive a feedback signal of a third pilot signal corresponding to the IRS element configuration from the terminal through the IRS. The processor may control the communication device to estimate a channel corresponding to a specific IRS element based on the first pilot signal, the second pilot signal and the third pilot signal. The second pilot signal is an uplink pilot signal, and the third pilot signal is a downlink pilot signal.

As an example, a non-transitory computer-readable medium storing at least one instruction may include the at least one instruction which is executable by a processor. The at least one instruction may instruct the computer-readable medium to receive a first pilot signal from a terminal and to estimate a channel between the terminal and a base station based on the first pilot signal. The at least one instruction may instruct the computer-readable medium to receive a second pilot signal corresponding to an intelligent reflecting surface (IRS) element configuration from the terminal through an IRS. The at least one instruction may instruct the computer-readable medium to receive a feedback signal of a third pilot signal corresponding to the IRS element configuration from the terminal through the IRS. The at least one instruction may instruct the computer-readable medium to estimate a channel corresponding to a specific IRS element based on the first pilot signal, the second pilot signal and the third pilot signal. The second pilot signal is an uplink pilot signal, and the third pilot signal is a downlink pilot signal.

As an example of the present disclosure, a method for operating a terminal in a wireless communication system may include transmitting a first pilot signal to a base station, transmitting a second pilot signal corresponding to an intelligent reflecting surface (IRS) element configuration to the base station through an IRS, receiving a third pilot signal corresponding to the IRS element configuration from the base station through the IRS, and transmitting a feedback signal of the third pilot signal to the base station. A channel between the terminal and the base station may be estimated based on the first pilot signal. A channel corresponding to a specific IRS element may be estimated based on the first pilot signal, the second pilot signal and the third pilot signal. The second pilot signal is an uplink pilot signal, and the third pilot signal is a downlink pilot signal.

As an example of the present disclosure, a terminal in a wireless communication system may include a transceiver and a processor coupled to the transceiver. The processor may control the transceiver to transmit a first pilot signal to a base station. The processor may control the transceiver to transmit a second pilot signal corresponding to an intelligent reflecting surface (IRS) element configuration to the base station through an IRS. The processor may control the transceiver to receive a third pilot signal corresponding to the IRS element configuration from the base station through the IRS. The processor may control the transceiver to transmit a feedback signal of the third pilot signal to the base station. A channel between the terminal and the base station may be estimated based on the first pilot signal. A channel corresponding to a specific IRS element may be estimated based on the first pilot signal, the second pilot signal and the third pilot signal. The second pilot signal is an uplink pilot signal, and the third pilot signal is a downlink pilot signal.

Effects obtained in the present disclosure are not limited to the above-mentioned effects, and other effects not mentioned above may be clearly derived and understood by those skilled in the art, to which a technical configuration of the present disclosure is applied, from the following description of embodiments of the present disclosure. That is, effects, which are not intended when implementing a configuration described in the present disclosure, may also be derived by those skilled in the art from the embodiments of the present disclosure.

### Advantageous Effects

As is apparent from the above description, the embodiments of the present disclosure have the following effects.

According to the present disclosure, channel estimation may be performed in a wireless communication system including an intelligent reflecting surface (IRS).

According to the present disclosure, overhead of channel estimation may be reduced based on a training sequence which is proportional to an IRS size.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### DESCRIPTION OF DRAWINGS

The accompanying drawings are provided to aid understanding of the present disclosure, and embodiments of the present disclosure may be provided together with a detailed description. However, the technical features of the present disclosure are not limited to a specific drawing, and features disclosed in each drawing may be combined with each other to constitute a new embodiment. Reference numerals in each drawing may mean structural elements.

FIG. 1 is a view showing an example of a communication system applicable to the present disclosure.

FIG. 2 is a view showing an example of a wireless apparatus applicable to the present disclosure.

FIG. 3 is a view showing another example of a wireless device applicable to the present disclosure.

FIG. 4 is a view showing an example of a hand-held device applicable to the present disclosure.

FIG. 5 is a view showing an example of a car or an autonomous driving car applicable to the present disclosure.

FIG. 6 is a diagram illustrating an example of an AI device applied to the present disclosure.

FIG. 7 is a diagram illustrating a method of processing a transmitted signal applied to the present disclosure.

FIG. 8 is a view showing an example of a communication structure providable in a 6G system applicable to the present disclosure.

FIG. 9 is a view showing an electromagnetic spectrum applicable to the present disclosure.

FIG. 10 is a view showing a THz communication method applicable to the present disclosure.

FIG. 11 is a view showing an example of a wireless communication system including an IRS applicable to the present disclosure.

FIG. 12 is a view showing an effect of channel estimation applicable to the present disclosure.

FIG. 13 is a view showing an example of a base station operating procedure applicable to the present disclosure.

FIG. 14 shows an example of a UE operating procedure applicable to the present disclosure.

### MODE FOR INVENTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

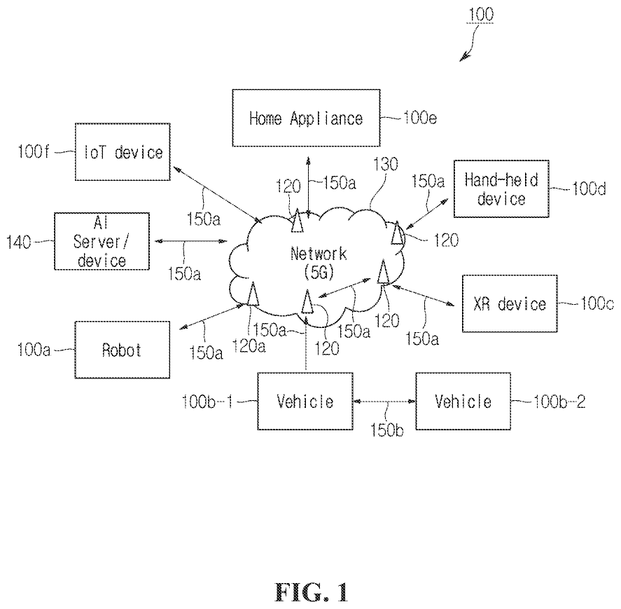

FIG. 1 is a view showing an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

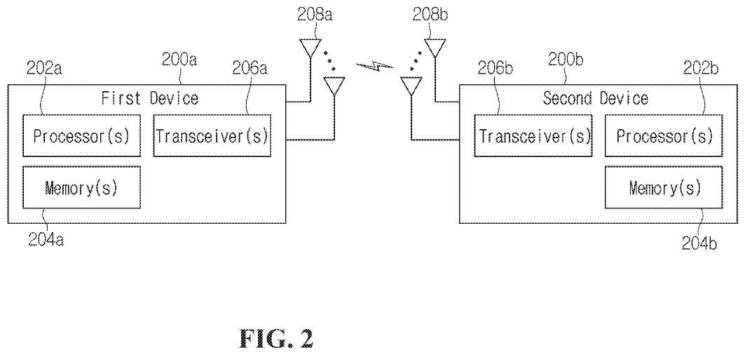

FIG. 2 is a view showing an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

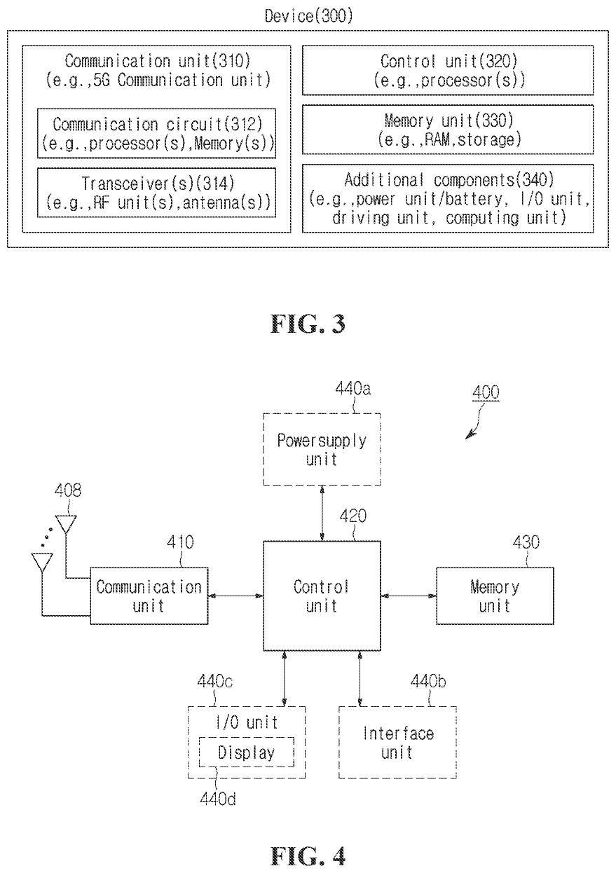

FIG. 3 is a view showing another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

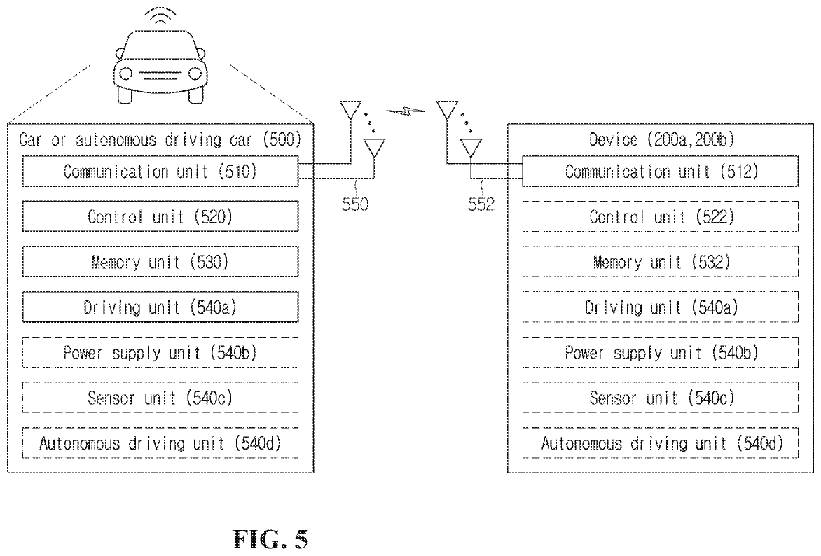

FIG. 4 is a view showing an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440a, an interface unit (interface) 440b, and an input/output unit 440c. An antenna unit (antenna) 408 may be part of the communication unit 410. The blocks 410 to 430/440a to 440c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440a may supply power to the hand-held device 400 and include a wired/wireless charging circuit, a battery, etc. The interface unit 440b may support connection between the hand-held device 400 and another external device. The interface unit 440b may include various ports (e.g., an audio input/output port and a video input/output port) for connection with the external device. The input/output unit 440c may receive or output video information/signals, audio information/signals, data and/or user input information. The input/output unit 440c may include a camera, a microphone, a user input unit, a display 440d, a speaker and/or a haptic module.

### Type of Wireless Device Applicable to the Present Disclosure

FIG. 5 is a view showing an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540a, a power supply unit (power supply) 540b, a sensor unit 540c, and an autonomous driving unit 540d. The antenna unit 550 may be configured as part of the communication unit 510. The blocks 510/530/540a to 540d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

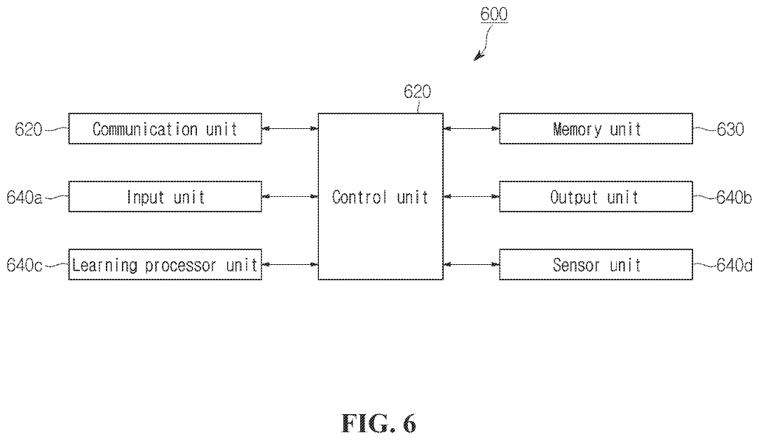

FIG. 6 is a diagram illustrating an example of an AI device applied to the present disclosure. For example, the AI device may be implemented as a fixed device or a movable device such as TV, projector, smartphone, PC, laptop, digital broadcasting terminal, tablet PC, wearable device, set-top box (STB), radio, washing machine, refrigerator, digital signage, robot, vehicle, etc.

Referring to FIG. 6, the AI device 600 may include a communication unit 610, a control unit 620, a memory unit 630, an input/output unit 640a/640b, a learning processor unit 640c and a sensor unit 640d. Blocks 610 to 630/640A to 640D may correspond to blocks 310 to 330/340 of FIG. 3, respectively.

The communication unit 610 may transmit and receive a wired and wireless signal (e.g., sensor information, user input, learning model, control signal, etc.) to and from external devices such as another AI device (e.g., 100x, 120, 140 in FIG. 1) or an AI server (140 in FIG. 1) using wired/wireless communication technology. To this end, the communication unit 610 may transmit information in the memory unit 630 to an external device or send a signal received from an external device to the memory unit 630.

The control unit 620 may determine at least one executable operation of the AI device 600 based on information determined or generated using a data analysis algorithm or machine learning algorithm. In addition, the control unit 620 may control the components of the AI device 600 to perform the determined operation. For example, the control unit 620 may request, search, receive, or utilize the data of the learning processor 640c or the memory unit 630, and control the components of the AI device 600 to perform predicted operation or operation determined to be preferred among at least one executable operation. In addition, the control unit 620 collects history information including a user's feedback on the operation content or operation of the AI device 600, and stores it in the memory unit 630 or the learning processor 640c or transmit it to an external device such as the AI server (140 in FIG. 1). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensor unit 640. Also, the memory unit 630 may store control information and/or software code required for operation/execution of the control unit 620.

The input unit 640a may obtain various types of data from the outside of the AI device 600. For example, the input unit 620 may obtain learning data for model learning, input data to which the learning model is applied, etc. The input unit 640a may include a camera, a microphone and/or a user input unit, etc. The output unit 640b may generate audio, video or tactile output. The output unit 640b may include a display unit, a speaker and/or a haptic module. The sensor unit 640 may obtain at least one of internal information of the AI device 600, surrounding environment information of the AI device 600 or user information using various sensors. The sensor unit 640 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, and/or a radar.

The learning processor unit 640c may train a model composed of an artificial neural network using learning data. The learning processor unit 640c may perform AI processing together with the learning processor unit of the AI server (140 in FIG. 1). The learning processor unit 640c may process information received from an external device through the communication unit 610 and/or information stored in the memory unit 630. In addition, the output value of the learning processor unit 640c may be transmitted to an external device through the communication unit 610 and/or stored in the memory unit 630.

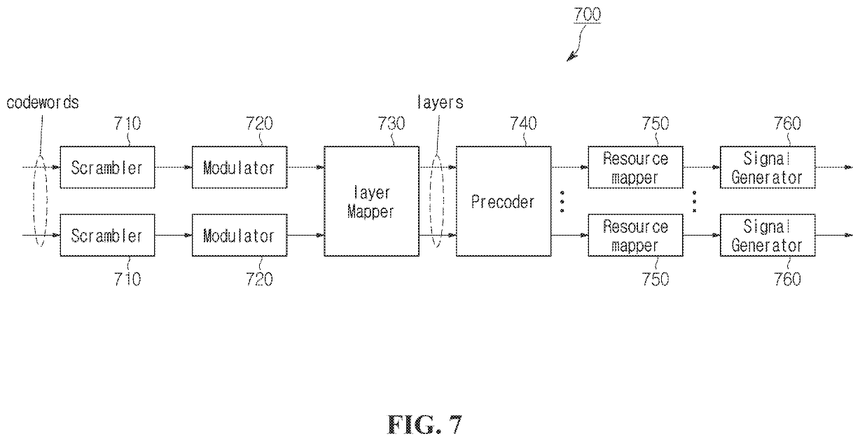

FIG. 7 is a diagram illustrating a method of processing a transmitted signal applied to the present disclosure. For example, the transmitted signal may be processed by a signal processing circuit. In this case, the signal processing circuit 700 may include a scrambler 710, a modulator 720, a layer mapper 730, a precoder 740, a resource mapper 750, and a signal generator 760. At this time, as an example, the operation/function of FIG. 7 may be performed by the processors 202a and 202b and/or the transceivers 206a and 206b of FIG. 2. Also, as an example, the hardware elements of FIG. 7 may be implemented in the processors 202a and 202b and/or the transceivers 206a and 206b of FIG. 2. As an example, blocks 710 to 760 may be implemented in the processors 202a and 202b of FIG. 2. Also, blocks 710 to 750 may be implemented in the processors 202a and 202b of FIG. 2, and block 760 may be implemented in the transceivers 206a and 206b of FIG. 2, and are not limited to the above-described embodiment.

A codeword may be converted into a radio signal through the signal processing circuit 700 of FIG. 7. Here, the codeword is an encoded bit sequence of an information block. Information blocks may include transport blocks (e.g., UL-SCH transport blocks, DL-SCH transport blocks). The radio signal may be transmitted through various physical channels (e.g., PUSCH, PDSCH). Specifically, the codeword may be converted into a scrambled bit sequence by the scrambler 710. A scramble sequence used for scrambling is generated based on an initialization value, and the initialization value may include ID information of a wireless device. The scrambled bit sequence may be modulated into a modulation symbol sequence by the modulator 720. The modulation method may include pi/2-binary phase shift keying (pi/2-BPSK), m-phase shift keying (m-PSK), m-quadrature amplitude modulation (m-QAM), and the like.

A complex modulation symbol sequence may be mapped to one or more transport layers by the layer mapper 730. Modulation symbols of each transport layer may be mapped to corresponding antenna port(s) by the precoder 740 (precoding). The output z of the precoder 740 may be obtained by multiplying the output y of the layer mapper 730 by a N*M precoding matrix W. Here, N is the number of antenna ports and M is the number of transport layers. Here, the precoder 740 may perform precoding after transform precoding (e.g., discrete Fourier transform (DFT)) on complex modulation symbols. Also, the precoder 740 may perform precoding without performing transform precoding.

The resource mapper 750 may map modulation symbols of each antenna port to time-frequency resources. The time-frequency resources may include a plurality of symbols (e.g., CP-OFDMA symbols and DFT-s-OFDMA symbols) in the time domain and may include a plurality of subcarriers in the frequency domain. The signal generator 760 generates a radio signal from the mapped modulation symbols, and the generated radio signal may be transmitted to other devices through each antenna. To this end, the signal generator 760 may include an inverse fast Fourier transform (IFFT) module, a cyclic prefix (CP) inserter, a digital-to-analog converter (DAC), a frequency uplink converter, and the like.

A signal processing process for a received signal in a wireless device may be configured as the reverse of the signal processing processes 710 to 760 of FIG. 7. For example, a wireless device (e.g., 200a and 200b of FIG. 2) may receive a radio signal from the outside through an antenna port/transceiver. The received radio signal may be converted into a baseband signal through a signal reconstructor. To this end, the signal reconstructor may include a frequency downlink converter, an analog-to-digital converter (ADC), a CP remover, and a fast Fourier transform (FFT) module. Thereafter, the baseband signal may be reconstructed to a codeword through a resource de-mapper process, a postcoding process, a demodulation process, and a de-scramble process. The codeword may be reconstructed to an original information block through decoding. Accordingly, a signal processing circuit (not shown) for a received signal may include a signal reconstructor, a resource de-mapper, a postcoder, a demodulator, a de-scrambler, and a decoder.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

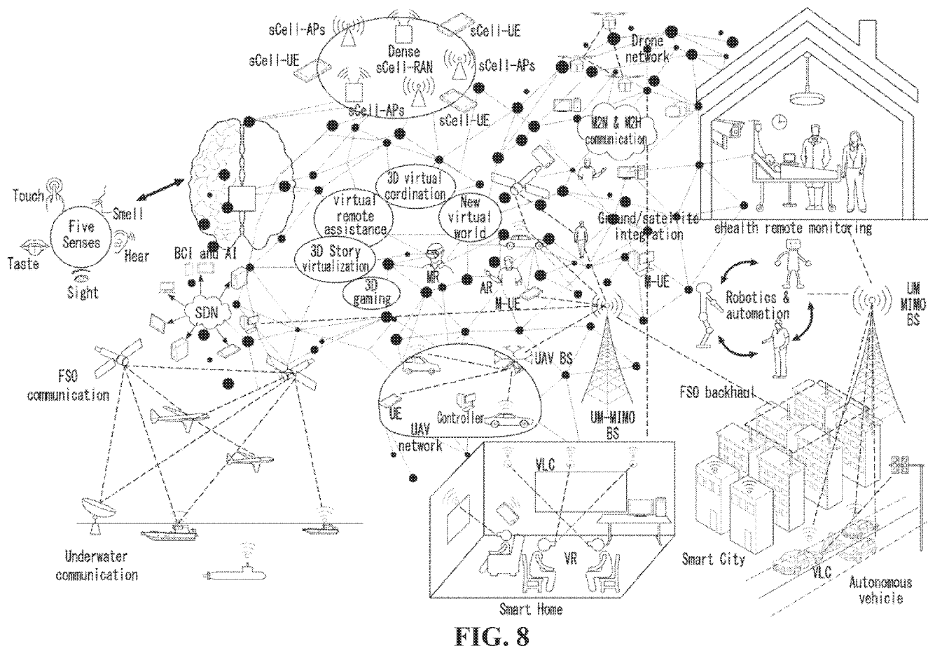

FIG. 8 is a view showing an example of a communication structure providable in a 6G system applicable to the present disclosure.

Referring to FIG. 8, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

### Core Implementation Technology of 6G System

### Artificial Intelligence (AI)

The most important and newly introduced technology for the 6G system is AI. AI was not involved in the 4G system. 5G systems will support partial or very limited AI. However, the 6G system will support AI for full automation. Advances in machine learning will create more intelligent networks for real-time communication in 6G. Introducing AI in communication may simplify and enhance real-time data transmission. AI may use a number of analytics to determine how complex target tasks are performed. In other words, AI may increase efficiency and reduce processing delay.

Time consuming tasks such as handover, network selection, and resource scheduling may be performed instantly by using AI. AI may also play an important role in machine-to-machine, machine-to-human and human-to-machine communication. In addition, AI may be a rapid communication in a brain computer interface (BCI). AI-based communication systems may be supported by metamaterials, intelligent structures, intelligent networks, intelligent devices, intelligent cognitive radios, self-sustained wireless networks, and machine learning.

Recently, attempts have been made to integrate AI with wireless communication systems, but application layers, network layers, and in particular, deep learning have been focused on the field of wireless resource management and allocation. However, such research is gradually developing into the MAC layer and the physical layer, and in particular, attempts to combine deep learning with wireless transmission are appearing in the physical layer. AI-based physical layer transmission means applying a signal processing and communication mechanism based on an AI driver rather than a traditional communication framework in fundamental signal processing and communication mechanisms. For example, deep learning-based channel coding and decoding, deep learning-based signal estimation and detection, deep learning-based multiple input multiple output (MIMO) mechanism, and AI-based resource scheduling and allocation may be included.

Machine learning may be used for channel estimation and channel tracking, and may be used for power allocation, interference cancellation, and the like in a downlink (DL) physical layer. Machine learning may also be used for antenna selection, power control, symbol detection, and the like in a MIMO system.

However, the application of DNN for transmission in the physical layer may have the following problems.

Deep learning-based AI algorithms require a lot of training data to optimize training parameters. However, due to limitations in obtaining data in a specific channel environment as training data, a lot of training data is used offline. This is because static training on training data in a specific channel environment may cause a contradiction between diversity and dynamic characteristics of a radio channel.

In addition, current deep learning mainly targets real signals. However, the signals of the physical layer of wireless communication are complex signals. In order to match the characteristics of a wireless communication signal, additional research on a neural network that detects a complex domain signal is required.

Hereinafter, machine learning will be described in greater detail.

Machine learning refers to a series of operations for training a machine to create a machine capable of performing a task which can be performed or is difficult to be performed by a person. Machine learning requires data and a learning model. In machine learning, data learning methods may be largely classified into three types: supervised learning, unsupervised learning, and reinforcement learning.

Neural network learning is to minimize errors in output. Neural network learning is a process of updating the weight of each node in the neural network by repeatedly inputting learning data to a neural network, calculating the output of the neural network for the learning data and the error of the target, and backpropagating the error of the neural network from the output layer of the neural network to the input layer in a direction to reduce the error.

Supervised learning uses learning data labeled with correct answers in the learning data, and unsupervised learning may not have correct answers labeled with the learning data. That is, for example, learning data in the case of supervised learning related to data classification may be data in which each learning data is labeled with a category. Labeled learning data is input to the neural network, and an error may be calculated by comparing the output (category) of the neural network and the label of the learning data. The calculated error is backpropagated in a reverse direction (i.e., from the output layer to the input layer) in the neural network, and the connection weight of each node of each layer of the neural network may be updated according to backpropagation. The amount of change in the connection weight of each updated node may be determined according to a learning rate. The neural network's computation of input data and backpropagation of errors may constitute a learning cycle (epoch). The learning rate may be applied differently according to the number of iterations of the learning cycle of the neural network. For example, in the early stages of neural network learning, a high learning rate is used to allow the neural network to quickly achieve a certain level of performance to increase efficiency, and in the late stage of learning, a low learning rate may be used to increase accuracy.

A learning method may vary according to characteristics of data. For example, when the purpose is to accurately predict data transmitted from a transmitter in a communication system by a receiver, it is preferable to perform learning using supervised learning rather than unsupervised learning or reinforcement learning.

The learning model corresponds to the human brain, and although the most basic linear model may be considered, a paradigm of machine learning that uses a neural network structure with high complexity such as artificial neural networks as a learning model is referred to as deep learning.

The neural network cord used in the learning method is largely classified into deep neural networks (DNN), convolutional deep neural networks (CNN), and recurrent Boltzmann machine (RNN), and this learning model may be applied.

### Terahertz (THz) Communication

THz communication is applicable to the 6G system. For example, a data rate may increase by increasing bandwidth. This may be performed by using sub-TH communication with wide bandwidth and applying advanced massive MIMO technology.

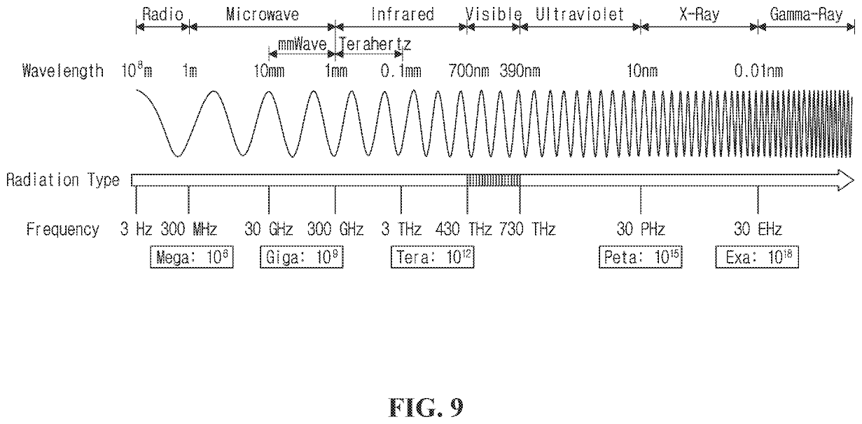

FIG. 9 is a view showing an electromagnetic spectrum applicable to the present disclosure. For example, referring to FIG. 9, THz waves which are known as sub-millimeter radiation, generally indicates a frequency band between 0.1 THz and 10 THz with a corresponding wavelength in a range of 0.03 mm to 3 mm. A band range of 100 GHz to 300 GHz (sub THz band) is regarded as a main part of the THz band for cellular communication. When the sub-THz band is added to the mmWave band, the 6G cellular communication capacity increases. 300 GHz to 3 THz of the defined THz band is in a far infrared (IR) frequency band. A band of 300 GHz to 3 THz is a part of an optical band but is at the border of the optical band and is just behind an RF band. Accordingly, the band of 300 GHz to 3 THz has similarity with RF.

The main characteristics of THz communication include (i) bandwidth widely available to support a very high data rate and (ii) high path loss occurring at a high frequency (a high directional antenna is indispensable). A narrow beam width generated in the high directional antenna reduces interference. The small wavelength of a THz signal allows a larger number of antenna elements to be integrated with a device and BS operating in this band.

Therefore, an advanced adaptive arrangement technology capable of overcoming a range limitation may be used.

### THz Wireless Communication

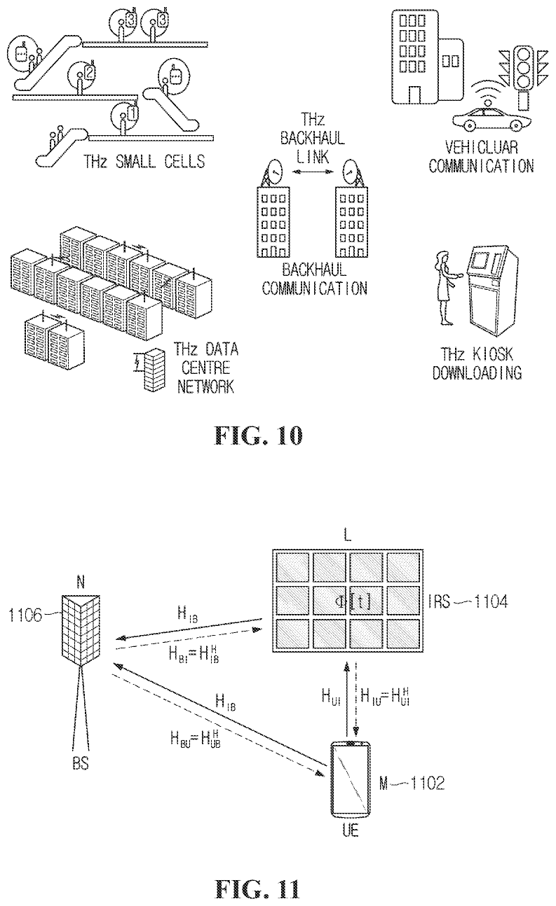

FIG. 10 is a view showing a THz communication method applicable to the present disclosure.

Referring to FIG. 10, THz wireless communication uses a THz wave having a frequency of approximately 0.1 to 10 THz (1 THz=1012 Hz), and may mean terahertz (THz) band wireless communication using a very high carrier frequency of 100 GHz or more. The THz wave is located between radio frequency (RF)/millimeter (mm) and infrared bands, and (i) transmits non-metallic/non-polarizable materials better than visible/infrared rays and has a shorter wavelength than the RF/millimeter wave and thus high straightness and is capable of beam convergence.

### SPECIFIC EMBODIMENTS OF THE PRESENT DISCLOSURE

The intelligent reflecting surface (IRS) is attracting attention as one of techniques for increasing communication speeds in post-5G communication. An existing multi-antenna technique can improve communication speeds through an antenna gain and a beamforming gain. However, the existing multi-antenna technique needs an active element such as a radio frequency (RF) chain. Accordingly, it requires a large scale placement of antennas, which may cause problems of cost and power consumption. An IRS may be composed of a passive element alone. As another example, an IRS may include a passive element and an active element. In case an IRS includes a passive element alone, a terminal or a base station may obtain a gain capable of being obtained by multiple antennas at a relatively low cost and power consumption. In case a communication system includes an IRS, channel estimation may not use existing techniques. An IRS including only a passive element may be incapable of independently transmitting and receiving signals. Accordingly, in case an IRS includes only a passive element, a channel between a base station and the IRS or between a terminal and the IRS is difficult to independently estimate. A base station and a terminal may observe a cascaded channel that has passed through an IRS. Based on this, the present disclosure proposes a new channel estimation method.

In a communication system including an IRS, the existing techniques focus on estimation accuracy, and a training sequence length required channel estimation tends to be long. A training sequence length may increase in proportion to a number of antennas and a number of elements of an IRS. Accordingly, in case a large IRS is used to support a high communication speed, a training sequence length may be longer than a coherence time. Accordingly, communication may be actually impossible. The present disclosure proposes a method of estimating a channel based on a training sequence which is linearly proportional to a size of an IRS irrespective of a number of antennas of a terminal and a base station.

FIG. 11 is a view FIG. 11 is a view showing an example of a wireless communication system including an IRS applicable to the present disclosure. A user equipment (UE) 1102 may communicate with a base station (BS) 1106. The UE 1102 may communicate with the BS 1106 through an IRS 1104. In the present disclosure, the terms ‘user’ and ‘UE’ may be used interchangeably.

In the present disclosure, a vertical vector and a matrix may be marked with boldface letters. A transpose and a Hermitian transpose may be marked with ( )^{T} and ( )^{H} respectively. A set of complex numbers may be marked with C. C^{axb} may denote a set of complex number matrices with a size of a×b. For a matrix A, A^{-B} and A^{-L} may denote a right-side inverse matrix and a left-side inverse matrix, respectively. For a vector a, a diagonal matrix with the element as a diagonal component may be marked with diag(a). For a vector a, a value of l₂-norm may be marked with ∥a∥₂. A multivariate normal distribution with a mean vector u and a covariance matrix Σ may be marked with CN(μ, Σ).

Hereinafter, abbreviations used in the present disclosure will be described.

Table 2 below show terms used in the present disclosure. A subscript including UL corresponds to an uplink, and a subscript including DL corresponds to a downlink.

TABLE 2

| | | | |
|---|---|---|---|
| N | Number of BS | [symbol] [t] ∈ [symbol] [symbol] , | Received signal at time |
| | antennas | [symbol] [t] ∈ [symbol] [symbol] | t |
| M | Number of | s_{UL}[t], s_{DL}[t] ∈ [symbol] | Transmitted signal at |
| | user(UE) antennas | | time t |
| L | Number of IRS | f[t] ∈ [symbol] ^{M×1}, w[t] ∈ [symbol] ^{N×1} | Transmission |
| | elements | | beamformer at time t |
| t | Time index | [symbol] [t] ∈ [0, 2π) | Phase value of l-st IRS |
| | | | element at time t |
| H_{UB} ∈ [symbol] ^{N×M} | Channel between | [symbol] [t] ∈ {0, 1} | Size value of l-st IRS |
| | user and BS | | element at time t |
| H [symbol] = | Channel between | Φ[t] = | IRS element set value |
| [h [symbol] h [symbol] ] | IRS and BS | diag([β [symbol] [t]e [symbol] . . . | at time t |
| ∈ [symbol] ^{N×L} | | β [symbol] [t] [symbol] ]^{T}) | |
| H [symbol] = | Channel between | N₀ | Noise variance |
| [h [symbol] h [symbol] ]^{H} | user and IRS | | |
| ∈ [symbol] ^{L×M} | | | |
| [symbol] = [symbol] h [symbol] ^{H} | First one- | n_{UL}[t]~ [symbol] (0, N₀I_{N}) | Noise at time t |
| | dimensional matrix | n_{DL}[t]~ [symbol] (0, N₀I_{M}) | |
| P_{UL}, P_{DL} | Transmission | B | Phase value |
| | power | | quantization bit depth |
| | | | of an IRS element |

[symbol]

indicates data missing or illegible when filed

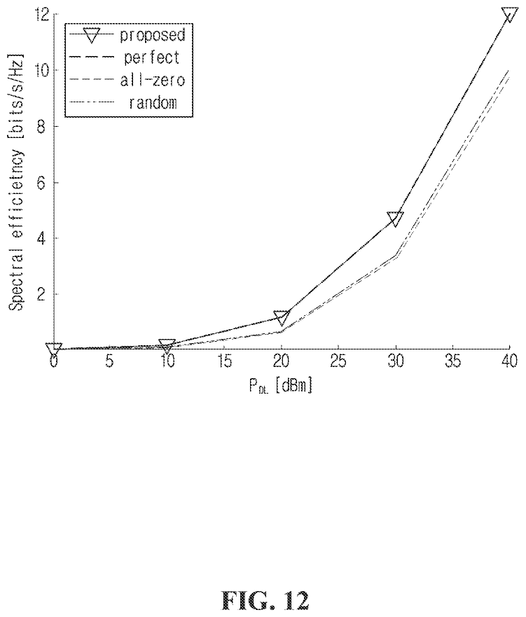

FIG. 12 is a view showing an effect of channel estimation applicable to the present disclosure. The present disclosure proposes a channel estimation method where a base station (BS) uses a uplink pilot signal and a downlink pilot signal that a user equipment (UE) delivers to the base station through analog feedback in a SU-MIMO system assuming TDD. The present disclosure may include receiving, by a BS, an uplink pilot signal in an environment where every IRS element is off and estimating a channel H_{UB} between a UE and the BS, removing, by the BS, an impact of H_{UB} from a received uplink pilot signal corresponding to an IRS element set value with a specific element on, removing, by the BS, the impact of H_{UB} from a received downlink pilot signal corresponding to the IRS element set value with the specific element on that the UE transmits to the BS through analog feedback, and estimating, by the BS, a one-dimensional matrix corresponding to the specific element by combining the two received signals with the impact of H_{UB} being removed. In addition, the BS may estimate as many one-dimensional matrices R₁ as a total number of IRS elements containing information on two channels H_{IB} and H_{UI} passing through an IRS by repeatedly applying the above-described procedure to every IRS element.

The BS may determine an IRS element set value. A received signal of the BS at time t may be expressed by Formula 1 below.

$${y}_{UL} [ t ] = ( {H}_{UB} + {H}_{IB} Φ [ t ] {H}_{UI} ) f [ t ] {s}_{UL} [ t ] + {n}_{UL} [ t ] \qquad Formula 1$$

It is assumed that a channel estimation is made within a coherence time. Accordingly, a channel is marked without a time index. A transmission beamformer may have a unit norm for satisfying a transmission power limit (∥f[t]∥₂²=1). A transmitted signal may be expressed by E{|s_{UL}[t]|²}≤P_{UL}. ABS may know a received signal for each of N antennas.

A TDD environment may establish channel reciprocity. At a time t, where channel reciprocity is applied, a received signal of a UE may be expressed by Formula 2 below.

$${y}_{DL} [ t ] = ( {H}_{UB}^{H} + {H}_{UI}^{H} {Φ}^{H} [ t ] {H}_{IB}^{H} ) w [ t ] {s}_{DL} [ t ] + {n}_{DL} [ t ] \qquad Formula 2$$

The above-described assumption of uplink may be similarly applied to a case of downlink. That is, the assumption of the unit norm of a transmission beamformer and a power limit of a transmitted signal may also be similarly applied to the case of downlink (∥w[t]∥₂²=1 (E{|s_{DL}[t]|²}≤P_{DL}). A UE may know a received signal for each of M antennas.

The present disclosure assumes a situation where analog feedback on a downlink signal received by a UE may be wholly given to a BS. Thus, the BS may first estimate a channel H_{UB} between the UE and the BS by using both an uplink signal and the downlink signal. In addition, based on an estimated value, the BS may estimate a cascaded channel by offsetting an impact of H_{UB} in the received signal. That is, the BS may estimate information on the cascaded channel consisting of H_{IB} and H_{UI} by offsetting the impact of H_{UB} in the received signal. The cascaded channel (BS-IRS-UE) may be expressed by Formula 3 below.

$$\begin{matrix}{H}_{IB} Φ [ t ] {H}_{UI} = {\sum }_{ℓ = 1}^{L} {β}_{ℓ} [ t ] {e}^{j {ϕ}_{ℓ} [ t ]} {h}_{IB , ℓ} {h}_{UI , ℓ}^{H} = {\sum }_{ℓ = 1}^{L} {β}_{ℓ} [ t ] {e}^{j {ϕ}_{ℓ} [ t ]} {R}_{ℓ} \\ {R}_{ℓ} = {h}_{IB , ℓ} {h}_{UI , ℓ}^{H}\end{matrix} \qquad Formula 3$$

Thus, a cascaded channel may be expressed by a weighted sum of one-dimensional matrix [symbol] . That is, a cascaded channel may be expressed by a weighted sum of [symbol] having a weight of [symbol] [t] [symbol] . The present disclosure proposes a method of estimating one-dimensional matrices [symbol] capable of expressing a same cascaded channel, instead of H_{IB} and H_{UI}.

Hereinafter will be described channel estimation not through an IRS between a UE and a BS. Hereinafter, in the present disclosure, a transmitted signal may use a constant that satisfies a transmission power limit (s_{UL}[t]=\sqrt{P_{UL}}, s_{DL}[t]=\sqrt{P_{DL}}). To estimate a channel H_{UB} between a UE and a BS, every IRS element may be set to have a size of 0 ( [symbol] =0, [symbol] ). In addition, a matrix may be formed by connecting received signals within a time range of 1≤t≤τ₁. A received signal may be expressed by Formula 4 below.

$$\begin{matrix}{y}_{UB} = [ {y}_{UL} [ 1 ] , … , y [ {τ}_{1} ] ] = \sqrt{{P}_{UL}} {H}_{UB} {F}_{UB} + {N}_{UB} \\ {F}_{UB} = [ f [ 1 ] , … , f [ {τ}_{1} ] ] ∈ {ℂ}^{M \times {τ}_{1}} \\ {N}_{UB} = [ {n}_{UL} [ 1 ] , … , {n}_{UL} [ {τ}_{1} ] ∈ {ℂ}^{M \times {τ}_{1}}\end{matrix} \qquad Formula 4$$

A matrix F_{UB} and a matrix N_{UB} are matrices that are formed based on connection between a transmission beamformer and a received noise within a time range of 1≤t≤τ₁. In case a beamformer F_{UB} is designed as a matrix with a right-side inverse matrix, a BS may estimate a channel H_{UB} using a received signal. The estimated H_{UB} may be expressed by Formula 5 below.

$${H}_{UB} = \frac{1}{\sqrt{{P}_{UL}}} {Y}_{UB} {F}_{UB}^{- R} = {H}_{UB} + \frac{1}{\sqrt{{P}_{UL}}} {N}_{UB} {F}_{UB}^{- R} \qquad Formula 5$$

Ĥ_{UB} denotes a direct channel estimation between a UE and a BS. As an example of a design method for a beamformer F_{UB}, F_{UB} may be designed by normalizing M rows in a discrete Fourier transform DFT matrix with a size of τ₁×τ₁ in a time domain of τ₁≥M. In this case, a right-side inverse matrix of F_{UB} may be obtained by normalizing an Hermitian transpose matrix of F_{UB}^{H}. The BS may remove an impact of H_{UB} from a received signal of the BS by using a channel estimated between a UE and the BS as follows.

$$\begin{matrix}{\tilde{y}}_{UL} [ t ] = {y}_{UL} [ t ] - {\tilde{H}}_{UB} f [ t ] \\ \sqrt{{P}_{UL}} ( {H}_{UB} - {\hat{H}}_{UB} ) f [ t ] + {H}_{IB} Φ [ t ] {H}_{UI} f [ t ] + {n}_{UL} [ t ] \\ = \sqrt{{P}_{UL}} {H}_{IB} Φ [ t ] {H}_{UI} f [ t ] + {\tilde{n}}_{UL} [ t ]\end{matrix} \qquad Formula 6$$

In addition, ñ_{UL}[t] may be defined as in Formula 4 by using a relation with Formula 5. In such a case, ñ_{UL}[t] may be considered as an actual noise of a system.

$${n}_{UL} [ t ] = - {N}_{UB} {F}_{UB}^{- R} f [ t ] + {n}_{UL} [ t ] \qquad Formula 7$$

Hereinafter, an estimation method of one-dimensional matrices will be described. The estimation of one-dimensional matrices may be expressed as a cooperative one-by-one (Co-OBO) channel estimation. During a time range of τ₁+1≤t≤τ₁+2L, L one-dimensional matrices [symbol] may be estimated. A set value for turning on only a [symbol] -th IRS element and turning off the remaining ones may be used to divide a time range into L periods with a length of 2 and perform estimation of a specific [symbol] in the [symbol] -th period. The set value for turning on only the [symbol] -th IRS element and turning off the remaining ones may be expressed by Formula 8 below.

$${Φ}^{( ℓ )} = diag ( {[ {0}_{ℓ - 1}^{T} , {e}^{j {ϕ}_{ℓ}} , {0}_{L - ℓ}^{T} ]}^{T} ) \qquad Formula 8$$

A [symbol] -th period interval τ₁+2( [symbol] −1)+1≤t≤τ₁+2 [symbol] , where estimation of [symbol] is performed, may be used by fixing the value Φ[t]= [symbol] . Accordingly, overhead may be reduced in cascaded channel estimation. For a first time of each period, a received signal [symbol] [symbol] \tilde{y}_{UL}[τ₁+2( [symbol] −1)+1] of a BS through an uplink is a special form of Formula 6, which may be represented by Formula 9 below.

$$\begin{matrix}{\tilde{y}}_{UL , ℓ} = \sqrt{{P}_{UL}} {H}_{IB} {Φ}^{( ℓ )} {H}_{UI} f [ t ] + {n}_{UL , ℓ} = {e}^{j {ϕ}_{ℓ}} {h}_{IB , ℓ} ( \sqrt{{P}_{UL}} {h}_{UI , ℓ}^{H} {f}_{ℓ} ) + {\tilde{n}}_{UL , ℓ} \\ {f}_{ℓ} = f [ {τ}_{1} + 2 ( ℓ - 1 ) + 1 ] \\ {\tilde{n}}_{UL , ℓ} = {\tilde{n}}_{UL} [ {τ}_{1} + 2 ( ℓ - 1 ) + 1 ]\end{matrix} \qquad Formula 9$$

An uplink received signal with a direct channel impact being removed may be expressed by [symbol] . A beamformer may be expressed by the above-described form of [symbol] . A noise signal may be expressed by the above-described form of [symbol] . Herein, \sqrt{P_{UL}} [symbol] may be considered as an actual scalar signal [symbol] .

Meanwhile, a downlink received signal y_{DL}[τ₁+2 [symbol] ] of a UE may be delivered to a BS through analog feedback for a second time of each period. As shown in Formula 6, the BS may remove an impact of H_{UB} and obtain a signal formed as in Formula 10 below.

$$\begin{matrix}{\tilde{y}}_{DL , ℓ} = {y}_{DL} [ {τ}_{1} + 2 ℓ ] - \sqrt{{P}_{D \vert L}} {\hat{H}}_{UB}^{H} {w}_{ℓ} \\ = \sqrt{{P}_{UL}} ( {H}_{UB}^{H} - {\hat{H}}_{UB}^{H} ) {w}_{ℓ} + \sqrt{{P}_{DL}} {e}^{- j {ϕ}_{ℓ}} {h}_{UI , ℓ} {h}_{IB , ℓ}^{H} {w}_{ℓ} + {n}_{DL , ℓ} \\ = {e}^{- j {ϕ}_{ℓ}} {h}_{UI , ℓ} ( \sqrt{{P}_{DL}} {h}_{IB , ℓ}^{H} {w}_{ℓ} ) + {\tilde{n}}_{DL} [ t ]\end{matrix} \qquad Formula 10$$

A downlink received signal with a direct channel impact being removed may be expressed by [symbol] . Herein, a beamformer is defined as [symbol] +w[τ₁+ [symbol] ] A noise signal is defined as [symbol] =n_{DL}[τ₁+ [symbol] ]. An actual noise of a corresponding system may be expressed in a form of

$$\begin{matrix}{\hat{R}}_{ℓ} = \frac{{\tilde{y}}_{UL , ℓ} {\tilde{y}}_{DL , ℓ}^{H}}{{( \sqrt{{P}_{DL}} {e}^{- j {ϕ}_{ℓ}} {w}_{ℓ} )}^{H} {\tilde{y}}_{UL , ℓ}} \\ = \frac{{h}_{IB , ℓ} {\tilde{s}}_{UL , ℓ} {\tilde{s}}_{DL , ℓ}^{*} {h}_{UI , ℓ}^{H}}{{\tilde{s}}_{DL , ℓ}^{*} {\tilde{s}}_{UL , ℓ} + \sqrt{{P}_{DL}} {e}^{- j {ϕ}_{ℓ}} {w}_{ℓ}^{H} {\tilde{n}}_{UL , ℓ}} + {\tilde{N}}_{ℓ} \\ = \frac{{R}_{ℓ}}{1 + {\tilde{n}}_{ℓ}} + {\tilde{N}}_{ℓ}\end{matrix} \qquad Formula 11$$

Similar to Formula 9, \sqrt{P_{DL}} [symbol] may be considered as an actual scalar signal [symbol] . In case a UE knows Ĥ_{UB}, the UE may first remove an impact of H_{UB}. Herein, the UE may first remove the impact of H_{UB} by performing calculation as shown in Formula 10. Next, the UE may deliver [symbol] to the BS through analog feedback. The BS may finally a one-dimensional matrix corresponding to the [symbol] -th IRS element by using the signals [symbol] and [symbol] , which are derived in the [symbol] -th period. The estimated one-dimensional matrix may be expressed by Formula 11 below.

$${\tilde{n}}_{DL , ℓ} = - \sqrt{\frac{{P}_{DL}}{{P}_{UL}}} {( {N}_{UB} {F}_{UB}^{- R} )}^{H} {w}_{ℓ} + {n}_{DL , ℓ} .$$

Here, [symbol] and [symbol] correspond to noise terms and may be expressed by Formula 12 below.

$$\begin{matrix}{\tilde{n}}_{ℓ} = \frac{\sqrt{{P}_{DL}} {e}^{- j {ϕ}_{ℓ}} {w}_{ℓ}^{H} {\tilde{n}}_{UL , ℓ}}{{\tilde{s}}_{UL , ℓ} {\tilde{s}}_{DL , ℓ}^{*}} , \\ {N}_{ℓ} = \frac{1}{1 + {\tilde{n}}_{ℓ}} ( \frac{{e}^{- j {ϕ}_{ℓ}} {h}_{IB , ℓ} {n}_{DL , ℓ}^{H}}{{\tilde{s}}_{DL , ℓ}^{*}} + \frac{{e}^{- j {ϕ}_{ℓ}}}{{\tilde{s}}_{UL , ℓ}} + \frac{{e}^{- j 2 {ϕ}_{ℓ}}}{{\tilde{s}}_{UL , ℓ} {\tilde{s}}_{DL , ℓ}^{*}} )\end{matrix} \qquad Formula 12$$

The above-described one-dimensional channel matrix estimation technique repeats estimation for each IRS element and thus performs as many estimations as a total of L IRS elements in ascending order. A BS may perform estimations for some elements of a total of L IRS elements requiring estimation in a desired order and is not limited to the above-described embodiment.

In case antennas of a BS and a UE and IRS elements are placed in UPA structures of 2×4, 2×2 and 2×4 respectively, channel estimation performance may be shown as in FIG. 12. A noise variance is N_0=−89 dBm. Quantization of B=2 bits is assumed. Accordingly, an IRS element set value may be set to a value maximizing SE among (2²)⁸ IRS element set values through exhaustive search. For comparison, FIG. 12 includes a result using information of a whole one-dimensional matrix (perfect), a result from a random phase value of an IRS element (random), and a result from all phase values of IRS elements set to 0 (all-zero). Referring to FIG. 12, when the information of the whole one-dimensional matrix is used, SE is maximized. In addition, almost likewise, the channel estimation technique through uplink and downlink signal interface, which is proposed by the present disclosure, maximizes SE.

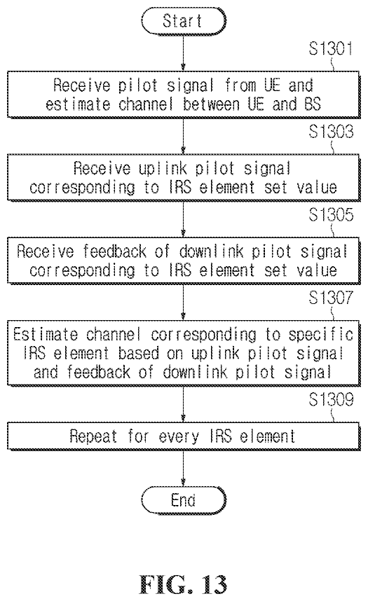

FIG. 13 is a view showing an example of a base station operating procedure applicable to the present disclosure. The present disclosure proposes a method of estimating a channel by a base station (BS) using an uplink pilot signal and analog feedback of a downlink pilot signal. As an example, the present disclosure proposes a method of estimating a channel including an IRS by a BS using an uplink pilot signal and analog feedback of a downlink pilot signal in a SU-MIMO system assuming TDD. The IRS may be composed of a passive element alone. As another example, the IRS may include an active element.

At step S1301, the BS may receive a pilot signal from a UE and estimate a channel between the UE and the BS. Specifically, the BS may receive an uplink pilot signal in an environment, where every IRS element is off, and estimate a channel H_{UB} between the UE and the BS. The BS may set a size of every IRS element to 0 and connect a received signal to form a matrix based on the above-described Formula 4 to Formula 7. In addition, the BS may receive a sounding reference signal (SRS) as the uplink pilot signal from the UE and estimate a channel between the UE and the BS.

At step S1303, the BS may receive an uplink pilot signal corresponding to an IRS element set value. Herein, the IRS element set value may be a value that turns on a specific IRS element. That is, the BS may receive an uplink pilot signal corresponding to the IRS element set value that turns on only the specific IRS element. The BS may remove an impact of the channel between the BS and the UE from the received uplink pilot corresponding to the IRS element set value that turns on only the specific IRS element. That is, BS may remove an impact of H_{UB} from the received uplink pilot corresponding to the IRS element set value that turns on only the specific IRS element.

As an example, the BS may receive a SRS as the uplink pilot signal corresponding to an IRS element set value. For example, the BS may receive a SRS corresponding to an IRS element set value, which turns on only a specific element, from the UE through an IRS. The BS may remove the impact of H_{UB} from the received SRS.

At step S1305, the BS may receive feedback of a downlink pilot signal corresponding to the IRS element set value. The BS may remove the impact of H_{UB} from the received feedback signal.

As an example, the BS may receive feedback of a channel state information-reference signal (CSI-RS) corresponding to the IRS element set value, which turns on only the specific element, from the UE. Specifically, the BS may receive the CSI-RS feedback from the UE. That is, the UE may receive the CSI-RS corresponding to the IRS element set value, which turns on only the specific element, from the BS through the IRS and then transmit CSI-RS feedback to the BS. The BS may remove the impact of H_{UB} from the received feedback signal of CSI-RS.

At step S1307, the BS may estimate a channel corresponding to the specific IRS element based on the uplink pilot signal and the feedback of the downlink pilot signal. As a concrete example, the BS may combine two signals with the impact of H_{UB} being removed therefrom at steps S1303 and S1305 and thus estimate a one-dimensional matrix corresponding to the specific IRS element. Herein, the BS may estimate the one-dimensional matrix based on the above-described Formula 8 to Formula 11.

As an example, the BS may receive a SRS corresponding to an IRS element set value, that turns on only a specific element, from the UE through the IRS and remove the impact of H_{UB} from the received SRS. In addition, the BS may receive a feedback signal of a CSI-RS corresponding to the IRS element set value, which turns on only the specific element, from the UE. The BS may remove the impact of H_{UB} from the received feedback signal of CSI-RS. The BS may estimate a cascaded channel through the IRS based on the SRS signal with the impact of H_{UB} being removed and the feedback signal of CSI-RS with the impact of H_{UB} being removed. That is, channel estimation corresponding to the specific IRS element may remove a channel impact between the UE and the BS from a second pilot signal and remove the channel impact between the UE and the BS.

At step S1309, the BS may repeat the above-described process for every IRS element. For example, the BS may repeatedly perform the steps S1303 to S1307 for every IRS element.

Meanwhile, a BS may transmit IRS element setting information to a UE. As an example, the specific IRS element setting information may include information on a number of the turned-on specific element. IRS element setting information may include information associated with an IRS element and is not limited to the above-described embodiment. The UE may transmit a pilot signal corresponding to the specific IRS element information based on the IRS element setting information. In addition, such signaling may be performed independently of or in combination with the above-described procedures.

As an example of the above-described procedure, a BS may receive a first pilot signal and estimate a channel between a UE and the BS based on the first pilot signal. In addition, the BS may receive a second pilot signal corresponding to an IRS element setting from the UE through an intelligent reflecting surface (IRS). The BS may receive a feedback signal of a third pilot signal corresponding to the IRS element setting from the UE through the IRS. A channel corresponding to a specific IRS element may be estimated based on the first pilot signal, the second pilot signal, and the third pilot signal. Herein, the second pilot signal is an uplink pilot signal, and the third pilot signal is a downlink pilot signal. As a concrete example, channel estimation corresponding to a specific IRS element may remove the channel impact between the UE and the BS from the second pilot signal and remove the channel impact between the UE and the BS from the third pilot signal. Specifically, in case the UE does not know H_{UB}, the UE may transmit feedback of the third pilot signal to the BS, and the BS may receive the feedback of the third pilot signal and remove the channel impact between the UE and the BS from the third pilot signal. As another example, channel estimation corresponding to the specific IRS element may remove the channel impact between the UE and the BS from the second pilot signal and receive the third pilot signal from which the channel impact between the UE and the BS is removed. Specifically, in case a UE and a BS know H_{UB}, the UE may remove a direct channel impact between the UE and the BS from a third pilot signal and transmit feedback to the BS. The BS may repeat channel estimation corresponding to a specific IRS element for every IRS element. The BS may transmit specific IRS element setting information to the UE. Herein, the specific IRS element setting information may include information on a number of the turned-on IRS element. A first pilot signal and the second pilot signal may be sounding reference signals (SRSs). The third pilot signal may be a channel state information-reference signal (CSI-RS).

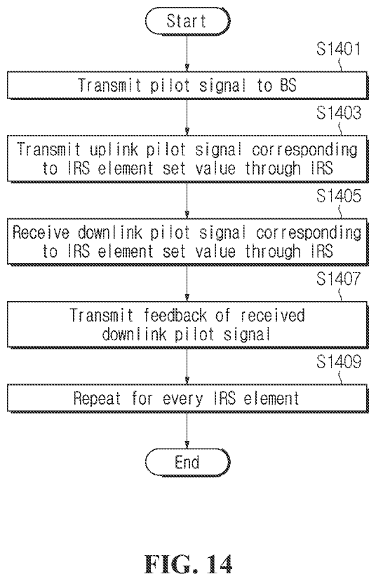

FIG. 14 shows an example of a UE operating procedure applicable to the present disclosure. At step S1401, a UE may transmit a pilot signal to a BS. For example, the UE may transmit an SRS to the BS in an environment where every IRS element is off. The BS may receive the pilot signal from the UE and estimate a channel between the UE and the BS. Specifically, the BS may receive an uplink pilot signal in an environment where every IRS element is off and estimate a channel H_{UB} between the UE and the BS.

At step S1403, the UE may transmit an uplink pilot signal corresponding to an element set value to th BS through an IRS. The BS may receive the uplink pilot signal corresponding to the IRS element set value. Herein, the IRS element set value may be a value that turns on a specific IRS element. That is, the BS may receive the uplink pilot signal corresponding to the IRS element set value that turns on only the specific IRS element. The BS may remove a channel impact between the BS and the UE from the received uplink pilot signal corresponding to the IRS element set value that turns on only the specific element.

At step S1405, the UE may receive a downlink pilot signal corresponding to the IRS element set value through IRS. For example, the UE may receive a CSI-RS corresponding to the IRS element set value from the BS through the IRS.

At step S1407, the UE may transmit feedback of the received downlink pilot signal. For example, the UE may transmit the feedback of the received CSI-RS to the BS.

At step S1409, the UE may repeat the above-described procedure for every IRS element. For example, the UE may repeatedly perform the steps S1403 to S1407 for every IRS element.

As the examples of the proposal method described above may also be included in one of the implementation methods of the present disclosure, it is an obvious fact that they may be considered as a type of proposal methods. In addition, the proposal methods described above may be implemented individually or in a combination (or merger) of some of them. A rule may be defined so that information on whether or not to apply the proposal methods (or information on the rules of the proposal methods) is notified from a base station to a terminal through a predefined signal (e.g., a physical layer signal or an upper layer signal).

The present disclosure may be embodied in other specific forms without departing from the technical ideas and essential features described in the present disclosure. Therefore, the above detailed description should not be construed as limiting in all respects and should be considered as an illustrative one. The scope of the present disclosure should be determined by rational interpretation of the appended claims, and all changes within the equivalent scope of the present disclosure are included in the scope of the present disclosure. In addition, claims having no explicit citation relationship in the claims may be combined to form an embodiment or to be included as a new claim by amendment after filing.

### INDUSTRIAL APPLICABILITY

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method performed by a base station in a wireless communication system, the method comprising:
receiving a first reference signal from a terminal;
estimating a first channel based on the first reference signal;
receiving a second reference signal from a terminal;
transmitting a third reference signal to the terminal;
receiving a feedback signal related to the third reference signal; and
estimating a second channel related to a specific element of an intelligent reflecting surface (IRS) based on the first reference signal, the second reference signal and the third reference signal,
wherein the second reference signal and the third reference signal are transmitted based on an IRS element configuration.

2. The method of claim 1, wherein the second channel is estimated by removing a channel impact of the first channel between the terminal and the base station from the second reference signal and by removing the channel impact between the terminal and the base station from the third reference signal.

3. The method of claim 1, wherein the second channel is estimated by removing a channel impact of the first channel between the terminal and the base station from the second reference signal and
wherein the feedback signal is determined based on removing the channel impact of the first channel between the terminal and the base station from the third reference signal.

4. The method of claim 1, wherein the estimating the second channel is repeated for every IRS element.

5. The method of claim 1, wherein the IRS element configuration includes information related to whether the specific element of IRS is turned on, and the specific element of IRS is a passive element.

6. The method of claim 5, wherein the base station transmits IRS element configuration information to the terminal, and the IRS element configuration information includes information related to a number of IRS elements which are turned on.

7. The method of claim 1, wherein the first reference signal and the second reference signal are sounding reference signals (SRS), and the third reference signal is a channel state information-reference signal (CSI-RS).

8. A base station in a wireless communication system, the base station comprising:
a transceiver; and
a processor coupled to the transceiver,
wherein the processor is configured to:
receive a first reference signal from a terminal;
estimate a first channel based on the first reference signal;
receive a second reference signal from a terminal;
transmit a third reference signal to the terminal;
receive a feedback signal related to the third reference signal; and
estimate a second channel related to a specific element of an intelligent reflecting surface (IRS) based on the first reference signal, the second reference signal and the third reference signal,
wherein the second reference signal and the third reference signal are transmitted based on an IRS element configuration.

9. The base station of claim 8, wherein the second channel is estimated by removing a channel impact of the first channel between the terminal and the base station from the second reference signal and by removing a channel impact between the terminal and the base station from the third reference signal.

10. The base station of claim 8, wherein the second channel is estimated by removing a channel impact of the first channel between the terminal and the base station from the second reference signal and
wherein the feedback signal is determined based on removing the channel impact of the first channel between the terminal and the base station from the third reference signal.

11. The base station of claim 8, wherein the estimating the second channel is repeated for every IRS element.

12. The base station of claim 8, wherein the IRS element configuration includes information related to whether the specific IRS element is turned on, and the specific IRS element is of a passive element.

13. The base station of claim 12, wherein the processor is further configured to control the transceiver to transmit IRS element configuration information to the terminal and
wherein the IRS element configuration information includes information related to a number of IRS elements which are turned on.

14. The base station of claim 8, wherein the first reference signal and the second reference signal are sounding reference signals (SRS), and the third reference signal is a channel state information-reference signal (CSI-RS).

15-17. (canceled)

18. A terminal in a wireless communication system, the terminal comprising:
a transceiver; and
a processor coupled to the transceiver,
wherein the processor is configured to:
transmit a first reference signal to a base station,
wherein a first channel between the terminal and a base station is estimated based on the first reference signal,
transmit a second reference signal to the base station,
receive a third reference signal from the base station, and
transmit a feedback signal related to the third reference signal to the base station,
wherein a second channel is estimated based on the first reference signal, the second reference signal and the third reference signal, and
the second reference signal and the third reference signal are transmitted based on an IRS element configuration.
